(19) United States
(12) Patent Application Publication
(10) Pub. No.: US 2018/0128012 A1
(43) Pub. Date: May 10, 2018

(54) HOME APPLIANCE DEVICE

(71) Applicant: BSH HAUSGERAETE GMBH, MUENCHEN (DE)

(72) Inventors: ALTAN ALYANAK, ISTANBUL (TR); EMRE EMEK, ISTANBUL (TR); ERCAN ENGIN, TEKIRDAG (TR); TANZER YILDIZGOECER, TEKIRDAG (TR)

(21) Appl. No.: 15/345,558

(22) Filed: Nov. 8, 2016

(51) Int. Cl. E05B 1/00; E05F 1/00; E05F 7/00; B67B 7/16; F25D 23/02; F25D 23/12; F25D 29/00

(52) U.S. Cl. CPC E05B 1/0015; E05F 1/00; E05F 7/00; F25D 29/006; F25D 23/028; F25D 23/12; B67B 7/16

(57) ABSTRACT

For the purpose of improving usability an emergency door handle configured for opening a home appliance, in particular a handle-less home appliance, in particular a home chiller appliance, is proposed, comprising: at least one handle unit having at least one handle element; and at least one opening unit having at least one protrusion element for transmitting an opening force exerted onto the handle element to a door of the home appliance.

### BACKGROUND OF THE INVENTION

The invention relates to an emergency door handle for opening a home appliance, in particular a handle-less home appliance, for example a home chiller appliance.

From the prior art handle-less refrigerators with electrically operated door opening assistants are known. Upon a user request for a door opening, the door opening assistant opens a door of the refrigerator partly.

### SUMMARY OF THE INVENTION

An object of the invention is, in particular, to improve a usability of a home appliance device. This object is achieved, according to the invention, by the features of claim 1, while further implementations and further developments of the invention may be gathered from the dependent claims.

An emergency door handle, for example a home appliance emergency door handle, configured for opening a home appliance, in particular a handle-less home appliance, for example a home chiller appliance, is proposed, comprising: at least one handle unit having at least one handle element; and at least one opening unit having at least one protrusion element for transmitting an opening force exerted onto the handle element to a door of the home appliance.

By means of the invention in particular improved characteristics regarding usability of a home appliance device are achievable. High-grade usage comfort for a user of a home appliance can be achieved. Furthermore, a user may be enabled to easily and/or safely access and/or use a handle-less home appliance during an emergency case, for instance during a power breakdown and/or a door opening assistance malfunction. Also, door handles may be omitted from a home appliance without limiting the usability of the home appliance in emergency cases.

In this context, “configured” is in particular to mean specifically programmed, designed and/or equipped. By an object being configured for a certain function is in particular to be understood that the object implements and/or fulfills said certain function in at least one application state and/or operating state. The home appliance is in particular provided for storing and preferably tempering victuals such as beverages, meat, fish, vegetables, fruits, milk and/or dairy products in at least one operating state, advantageously for the purpose of enhancing a keepability of the stored victuals. The home appliance may for example be embodied as a home chiller appliance, which is in at least one operating state configured for cooling victuals. The home chiller appliance could in particular be embodied as a climate cabinet, an ice-box, a refrigerator, a freezer, a refrigerator-freezer combination and/or a wine cooler. However, the home appliance could also be embodied as a home appliance for warming and in particular for cooking victuals, e.g., an oven, a steamer and/or a microwave.

In this context, a “handle-less home appliance” is to be understood as a home appliance featuring at least one door without a visible door handle. However, the door may feature a door handle which is at least partly, preferably completely hidden in a closed state, and becomes at least partly, preferably fully visible and/or accessible in at least one partly opened state of the door. The home appliance may be a french door home appliance, for example a home chiller appliance, possibly with two doors that are arranged next to each other, in particular side by side, and are hinged on opposite sides of a main body of the home appliance.

In particular, the emergency door handle may be implemented separately from the home appliance. The emergency door handle can in particular be entirely removed from the home appliance. In particular, the emergency door handle may not be a part of the home appliance. The emergency door handle can be configured for opening different types of home appliances.

In particular, the emergency door handle may define at least one advancement direction in which the emergency door handle is to be moved towards and/or into the home appliance prior to opening it. For instance, the emergency door handle can be configured for being slid and/or inserted into a space of the home appliance, preferably between the door and a main body of the home appliance or between two adjacent doors of the home appliance. It is also conceivable that the emergency door handle is configured for being moved in the advancement direction adjacently to the door of the home appliance. In particular, the emergency door handle may be configured for being moved in the advancement direction at least up to a contact position.

The protrusion element may be in contact with the door or the doors of the home appliance when the emergency door handle is in the contact position. Advantageously, the protrusion element features at least one contact surface for contacting for example the door during opening the door, which contact surface is oriented at least substantially perpendicularly to the advancement direction. Preferably, the contact surface faces in a direction opposite to the advancement direction. The protrusion element may be bar-shaped and/or plate-shaped. It is conceivable that the opening unit features several, in particular differently and/or identically implemented protrusion elements, which may be arranged on one common axis. For instance, the opening unit can feature two or three or four or five or more protrusion elements. In this context, “at least substantially perpendicular” is in particular to mean an orientation of a direction with respect to a reference direction, in particular in a plane, wherein the direction and the reference direction include an angle of 90°, the orientation in particular having a deviation of less than 15°, advantageously of less than 10° and particularly advantageously of less than 2°.

The force exerted onto the handle element may be a pulling force during an opening of the door and/or a force generated by a user handling the emergency door handle. For example, the handle element features at least one gripping surface which is oriented at least substantially perpendicular to the advancement direction and/or facing in the advancement direction. In particular, a main extension direction of the handle element is oriented at least substantially perpendicularly to the advancement direction. The handle element may be plate-shaped. The handle element may be configured for being gripped with at least two fingers, or with five fingers, or with one hand. The handle element may feature at least one gripping opening, which in particular implements the gripping surface, for example embodied as a portion of an edge of the gripping opening.

In particular, the handle element may at least partly, or at least to a large extent or completely be made of plastic. It is also conceivable that the handle element is at least partly, or at least to a large extent or completely made of metal. In particular, the protrusion element is at least partly or at least to a large extent or completely made of plastic. It is also conceivable that the protrusion element is at least partly or at least to a large extent or completely made of metal. The emergency door handle may be made of one piece. The term “at least to a large extent” is in particular to mean to an extent of at least 55%, or to an extent of at least 65%, or to an extent of at least 75%, or to an extent of at least 85% or to an extent of at least 95%.

In an embodiment of the invention it is proposed that the opening unit features at least one support element that is connected to the handle unit, and that the protrusion element is connected to the support element. It is conceivable that the protrusion element is at least partly implemented integrally, or implemented integrally, with the support element. It is further conceivable that the handle element is implemented integrally with the support element. The support element may be made of one piece. In particular, the support element is at least partly or at least to a large extent or completely made of plastic. It is also conceivable that the support element is at least partly or at least to a large extent or completely made of metal. In particular, the support element may be configured for transmitting the force exerted on the handle element to the protrusion element. In particular, the support element may feature at least one front end which is in particular located on a side of the support element opposite the handle unit and/or which defines a foremost point of the support element and/or of the emergency door handle along the advancement direction. The protrusion element may in particular be connected to the support element at a front end of the support element. In particular, the support element may feature at least one rear end, which is arranged next to the handle unit and/or next to the handle element and/or on a side of the support element opposite the front end. In this context, the term “a first object and a second object being at least partly implemented integrally” is in particular to mean that at least one component of the first object and at least one component of the second object are implemented integrally with each other. “Implemented integrally” is in particular to mean, in this context, connected at least by substance-to-substance bond, e.g., by a welding process, an adhesive bonding, an injection-molding process and/or by another process that is deemed expedient by a person having ordinary skill in the art. Advantageously, “implemented integrally” could in particular mean made of one piece. “Made of one piece” is in particular to mean, in this context, manufactured from one single piece, e.g., by production from one single cast and/or by manufacturing in a one-component or multi-component injection-molding process, and advantageously from a single blank. As a result, advantageous properties regarding compactness can be achieved.

Structural simplicity and/or cheap and/or easy manufacturability may be achieved if the support element is plate-shaped. The support element and the handle element may form a common plate.

For the purpose of improving stability while pulling a home appliance door open, it is proposed that the protrusion element, in particular in at least one basic position of the protrusion element, is oriented inclined with respect to the support element, in particular inclined towards the support element on a side of the protrusion element that faces away from the front end of the support element. The protrusion element may be connected to the support element in the manner of an, for example one-sided or two-sided, arrowhead. For example, the protrusion element and the support element may include an angle smaller than 90° or no greater than 75° or no greater than 60° or no greater than 45°.

Easy introduction of an emergency door handle into a home appliance, in particular in an emergency case, can be enabled if the protrusion element is movable into at least one advancement position, in which the protrusion element is at least partly oriented at least substantially parallel or parallel to the support element. At least a tip of the protrusion element may be oriented at least substantially parallel or parallel to the support element in the advancement position. It is also conceivable that the entire protrusion element is oriented at least substantially parallel or parallel to the support element in the advancement position. In particular, the protrusion element may be more inclined, in particular significantly more inclined, towards the support element in the advancement position than in the basic position. It is conceivable that the protrusion element is swivel-mounted to the support element, in particular swivel-mounted about a swivel axis which is preferably oriented at least substantially parallel or parallel to a main extension plane of the support element, which swivel axis is advantageously arranged inside the support element and/or in the main extension plane of the support element. The support element may feature at least one receiving recess in which the protrusion element is at least partly or completely arranged in the advancement position. In particular, the recess can be implemented as a through hole and/or a groove and/or an indentation. A “main extension plane” of an object is, in particular, to be understood as a plane extending parallel to a largest side of an imaginary rectangular cuboid which only just entirely encloses the object and preferably extends through a geometric center of the object.

A reduced diversity of parts can be achieved if the protrusion element is at least partly macroscopically, in particular elastically and/or non-destructively deformable. Preferably, the protrusion element is bendable towards the support element, advantageously in a connection region between the protrusion element and the support element. The protrusion element may at least partly be flexible. The protrusion element may at least partly be bendable into the receiving recess of the support element. In particular, the protrusion element may at least partly be macroscopically deformed in the advancement position. In this context, a “macroscopically deformable object” is, in particular, to be understood as an object featuring in at least one direction at least one extension, which can be, in particular temporarily and/or without damage, altered by at least 1% or by at least 5% or by at least 20% or by at least 50% when a force is applied onto the object that is no greater than 100 kN mm⁻² or no greater than 10 kN mm⁻² or no greater than 1 kN mm⁻².

The emergency door handle may be repeatedly usable if the opening unit features at least one spring element for restoring the protrusion element into at least one basic position. It is conceivable that the spring element may be configured for generating at least one restoring force, particularly for pushing the protrusion element at least partly away from the support element into the basic position. The protrusion element and the spring element may be implemented integrally. The protrusion element, in particular a part of the protrusion element that is connected to the support element, may implement the spring element. In particular, the protrusion unit may implement two functions, namely transmission of the opening force to the door and restoring itself into the basic position. It is also conceivable that the spring element is embodied separately from the protrusion element. In particular, the spring element can be implemented as a spring, for example as a metal spring or a plastic spring.

For the purpose of avoiding operating errors and/or improving usage comfort, it is proposed that the emergency door handle further comprises a stop unit with at least one stop element arranged between the handle unit and the opening unit, the stop unit defining a maximum advancement length of the opening unit. Preferably, the stop element defines the maximum advancement length of the opening unit. In particular, the stop element may come into contact with the door or with another part of the home appliance when the emergency door handle is moved towards the home appliance and/or into the home appliance in the advancement direction, and in particular blocks a further movement of the emergency door handle in the advancement direction in case the emergency door handle is moved towards the home appliance and/or into the home appliance in the advancement direction. The stop unit and/or the stop element may at least partly be implemented integrally or implemented integrally, with the opening unit, in particular with the support element, and/or with the handle unit, in particular with the handle element.

For the purpose of providing an intuitive manageability, it is proposed that the stop element is arranged perpendicularly to the handle element and/or arranged perpendicularly to the opening unit. The stop element may be plate-shaped. The stop element may form a cross with a plate implemented by the handle element and the support element.

It is further proposed that the handle unit may comprise a functional unit which provides at least one additional function, in particular at least one additional kitchen tool function. The emergency door handle may be usable as a kitchen tool. For instance, the kitchen tool function may encompass the functionality of a knife and/or a fork and/or a spoon and/or a spatula and/or a cake shovel and/or a meat thermometer or others. Alternatively or additionally it is conceivable that the function unit is at least partly magnetic. The function unit may be configured for magnetically connecting the emergency door handle to a metal surface, for instance to the door of the home appliance. The functional unit may at least partly be implemented as a bottle opener.

For the purpose of reducing a diversity of parts, it is proposed that the functional unit and the handle element are at least partly implemented integrally, or implemented integrally, with each other. The functional unit may be a part of the handle unit. The handle element may implement the functional unit. For example, handle element may feature a bottle opener. The gripping opening may be implemented as an opening of a bottle opener.

The invention further covers a system comprising at least one handle-less home appliance, for example a home chiller appliance, and at least one emergency door handle according to the invention. As a result, a high degree of user-friendliness and/or usability, in particular in an emergency case, for instance during a power breakdown, can be achieved.

Usability of a home appliance, for example of a home chiller appliance, in particular in an emergency case, for instance during a power breakdown, is improved by a method for opening the door of the home appliance in at least one emergency case, wherein the emergency door handle according to the invention is used for opening the door. The method preferably comprising the step of pushing the emergency door handle into an opening of the home appliance along at least one advancement direction, wherein the at least one protrusion element engages behind at least an edge delimiting the opening, preferably followed by the step of pulling the emergency door handle along a direction opposite to the at least one advancement direction, wherein the door will be opened. Said opening may be a slit or slot surrounded at one side by a door of the home appliance and surrounded at the other side by a further door of the home appliance or by a kitchen wall segment or by a further home appliance.

Herein the home appliance device and/or the method according to the invention are/is not to be limited to the application and implementation described above. In particular, for the purpose of fulfilling a functionality herein described, the home appliance device and/or the method according to the invention may comprise a number of respective elements, structural components, units and/or steps that differ from the number mentioned herein. Furthermore, regarding the value ranges mentioned in this disclosure, values within the limits mentioned are to be understood to be also disclosed and to be used as applicable.

Further advantages may become apparent from the following description of the drawing. In the drawing exemplary embodiments of the invention are shown. The drawing, the description and the claims contain a plurality of features in combination. The person having ordinary skill in the art will purposefully also consider the features separately and will find further expedient combinations.

If there is more than one specimen of a certain object, only one of these is given a reference numeral in the figures and in the description. The description of this specimen may be correspondingly transferred to the other specimens of the object.

### BRIEF DESCRIPTION OF THE SEVERAL VIEWS OF THE DRAWING

FIG. 1 a system comprising a home appliance and an emergency door handle, in a schematic front view,

FIG. 2 the emergency door handle in a perspective view,

FIG. 3 a schematic flow chart of a method for opening a door of the home appliance,

FIG. 4 a portion of the system, with the emergency door handle located outside the home appliance, in a schematic top view,

FIG. 5 the portion of the system, with the emergency door handle partly located inside the home appliance, in a schematic top view,

FIG. 6 a portion of the emergency door handle, including a protrusion element of the emergency door handle in an advancement position, in a schematic top view,

FIG. 7 a first alternative emergency door handle in a perspective view,

FIG. 8 the first alternative emergency door handle in a schematic lateral view,

FIG. 9 the first alternative emergency door handle in an opening position, in a schematic top view,

FIG. 10 the first alternative emergency door handle in a basic position, in a schematic top view,

FIG. 11 the first alternative emergency door handle in an advancement position, in a schematic top view,

FIG. 12 a second alternative emergency door handle in a perspective view, and

FIG. 13 the second alternative emergency door handle in a schematic top view.

### DETAILED DESCRIPTION OF THE INVENTION

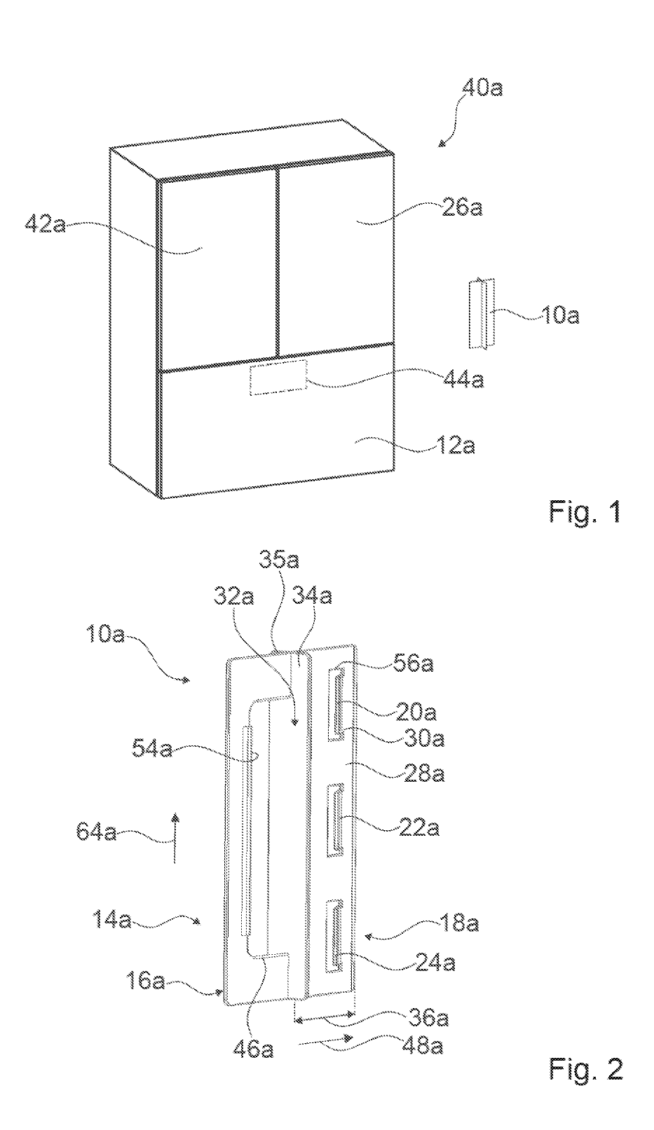

FIG. 1 shows a system 40a comprising a home appliance 12a and an emergency door handle 10a in a schematic front view. The home appliance 12a is a handle-less home appliance 12a. The home appliance 12a is a home chiller appliance, in particular a refrigerator. The home appliance 12a comprises a door 26a. In the case shown the home appliance 12a comprises an additional door 42a. The home appliance 12a is a french-door refrigerator. However, it is also conceivable that the home appliance is implemented as a different type of home appliance as mentioned above. The home appliance 12a features an electronic door opening assistant 44a configured for opening the door 26a and/or the door 42a upon a user request.

FIG. 2 shows the emergency door handle 10a in a perspective view. The emergency door handle 10a is configured for opening the home appliance 12a. The emergency door handle 10a comprises a handle unit 14a having at least one handle element 16a. Furthermore, the emergency door handle 10a comprises an opening unit 18a having at least one protrusion element 20a for transmitting an opening force exerted onto the handle element 16a to the door 26a of the home appliance 12a.

In the case shown the opening unit 18a comprises three protrusion elements 20a, 22a, 24a. The protrusion elements 20a, 22a, 24a are oriented on one axis. The protrusion elements 20a, 22a, 24a are embodied identically.

The emergency door handle 10a defines at least one advancement direction 48a in which the emergency door handle 10a is to be moved towards and/or into the home appliance 12a prior to opening it.

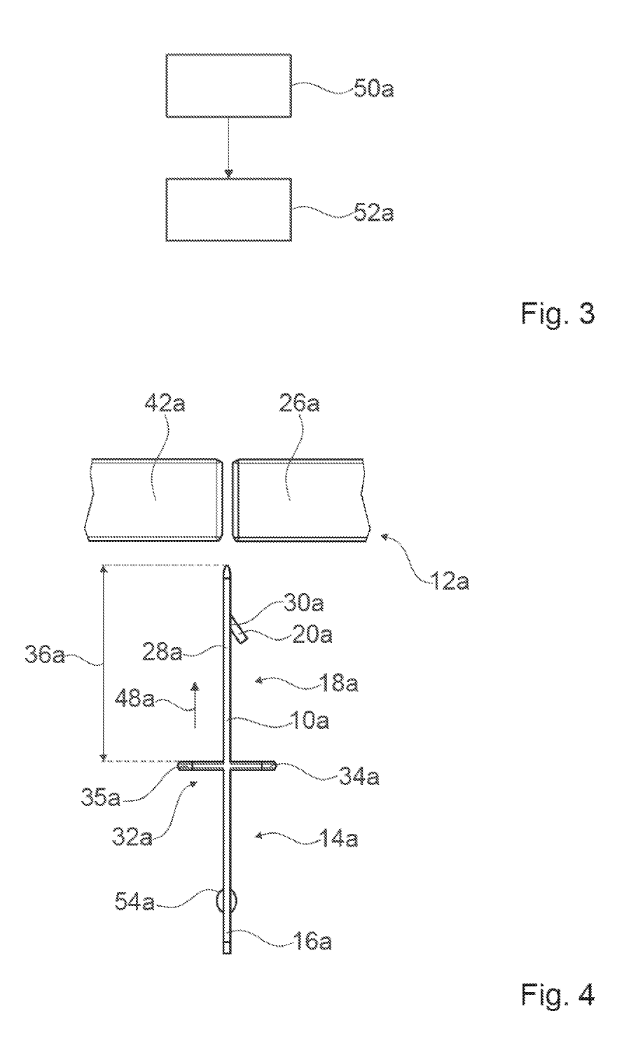

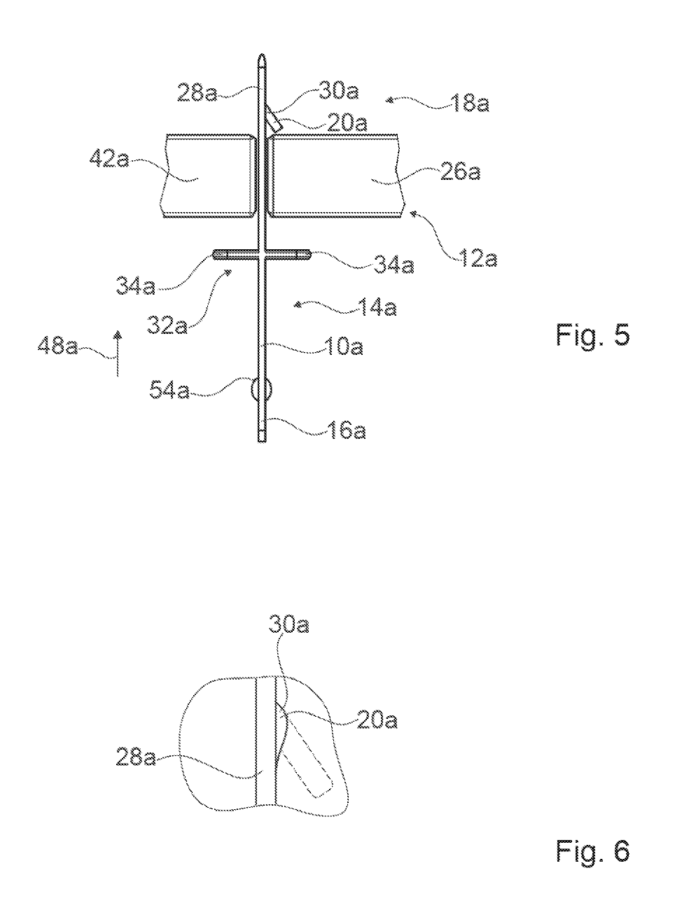

FIG. 3 shows a schematic flow chart of a method for opening the door 26a of the home appliance 12a. The method is further illustrated in FIGS. 4 and 5. FIG. 4 shows a portion of the system 40a with the emergency door handle 10a located outside the home appliance 12a, in a schematic top view. FIG. 5 shows the portion of the system 40a with the emergency door handle 10a partly located inside the home appliance 12a, in a schematic top view. In FIG. 5 the emergency door handle 10a is shown in an opening position.

In an emergency case, for instance in case of a power breakdown, wherein the door opening assistant 44a is in particular without power and thus does not open the door 26a and/or the door 42a upon a user request, the emergency door handle 10a is brought into the opening position in a first method step 50a by moving the emergency door handle 10a in the advancement direction 48a towards the home appliance 12a. In the case shown the emergency door handle 10a is introduced into the home appliance 12a between the doors 26a, 42a of the home appliance 12a. When the emergency door handle 10a has been brought into the opening position, the door 26a is opened in a second method step 52a. A user can open the door 26a at least partly by exerting a pulling force onto the handle element 16a. Once the door 26a is partly open, the user can grab the door 26a on a lateral side and/or on an inside in order to completely open it. Alternatively, the user can completely open the door 26a using the emergency door handle 10a. During opening, the pulling force is transmitted to the door 26a by the protrusion element 20a. During opening, the protrusion element 20a is hooked into the door 26a. In a similar fashion it is conceivable that the additional door 42a is at least partly opened. It is further conceivable that both doors 26a, 42a are at least partly opened.

It is also conceivable that an emergency door handle is introduced into a home appliance between a door and a housing of the home appliance, in particular if the home appliance features a single door. Furthermore, it is conceivable that an emergency door handle is hooked into or interlocked with a lateral side of a door of a home appliance for opening the door instead of being introduced into the home appliance.

The handle element 16a is plate-shaped. The handle element 16a is made of plastic. The handle element 16a features a gripping opening 46a. The gripping opening 46a has an extension of approximately 10 cm in a height direction 64a that is perpendicular to the advancement direction 48a. The handle element 16a implements a handle that can be grabbed by a user with one hand. However, other dimensions of a handle element and other elements of an emergency door handle are conceivable. For instance, a handle element can be configured for being grabbed with one or two fingers only and accordingly may be of smaller size.

The handle element 16a features a gripping surface 54a, which is oriented at least substantially perpendicularly to the advancement direction 48a. The gripping surface 54a faces in the advancement direction 48a. When a user exerts a pulling force onto the emergency door handle 10a, a force is exerted onto the gripping surface 54a.

The opening unit 18a features a support element 28a that is connected to the handle unit 14a. The protrusion element 20a is connected to the support element 28a. The support element 28a is plate-shaped. The support element 28a is implemented integrally with the handle element 16a. The support element 28a is made of plastic. The protrusion element 20a is implemented integrally with the support element 28a. The protrusion element 20a is made of plastic.

The protrusion element 20a is oriented inclined with respect to the support element 28a. The protrusion element 20a is inclined rearwards with respect to the advancement direction 48a.

The protrusion element 20a is movable into at least one advancement position, in which the protrusion element 20a is at least partly oriented at least substantially parallel to the support element 28a. A portion of the emergency door handle 10a including the protrusion element 20a in the advancement position is shown in FIG. 6 in a schematic top view. The support element 28a features a receiving recess 56a in which the protrusion element 20a is at least partly located in the advancement position. The receiving recess 56a is implemented as an opening. In the advancement position the protrusion element 20a can be slid into the home appliance 12a.

The protrusion element 20a is at least partly macroscopically deformable. In FIGS. 2, 3 and 4 the protrusion element 20a is shown in a basic position. The protrusion element 20a is bendable, in particular bendable from the basic position into the advancement position.

The opening unit 18a features a spring element 30a for restoring the protrusion element 20a into the basic position. In the case shown the spring element 30a is a portion of the protrusion element 20a. The spring element 30a is connected to the support element 28a. The spring element 30a is implemented integrally with the protrusion element 20a and with the support element 28a. The spring element 30a is configured for generating a restoring force when the protrusion element 20a is in the advancement position. When the protrusion element 20a has been introduced into the home appliance 12a, the spring element 30a restores the basic position of the protrusion element 20a. Hence, the protrusion element 20a is hooked to the door 26a when a user pulls on the handle unit 14a.

The emergency door handle 10a features a stop unit 32a with a stop element 34a. The stop element 34a is arranged between the handle unit 14a and the opening unit 18a. The stop element 34a is integrated integrally with the handle element 16a. The stop element 34a is integrated integrally with the support element 28a. The stop unit 32a defines a maximum advancement length 36a of the opening unit 18a. The maximum advancement length 36a is a distance between a foremost point of the support element 28a and the stop element 34a. The maximum advancement length 36a is equal to a maximum distance by which the support element 28a can be slid into the home appliance 12a.

The stop element 34a is arranged perpendicularly to the handle element 16a. The stop unit 32a features an additional stop element 35a which is implemented mirror-symmetrically to the stop element 34a.

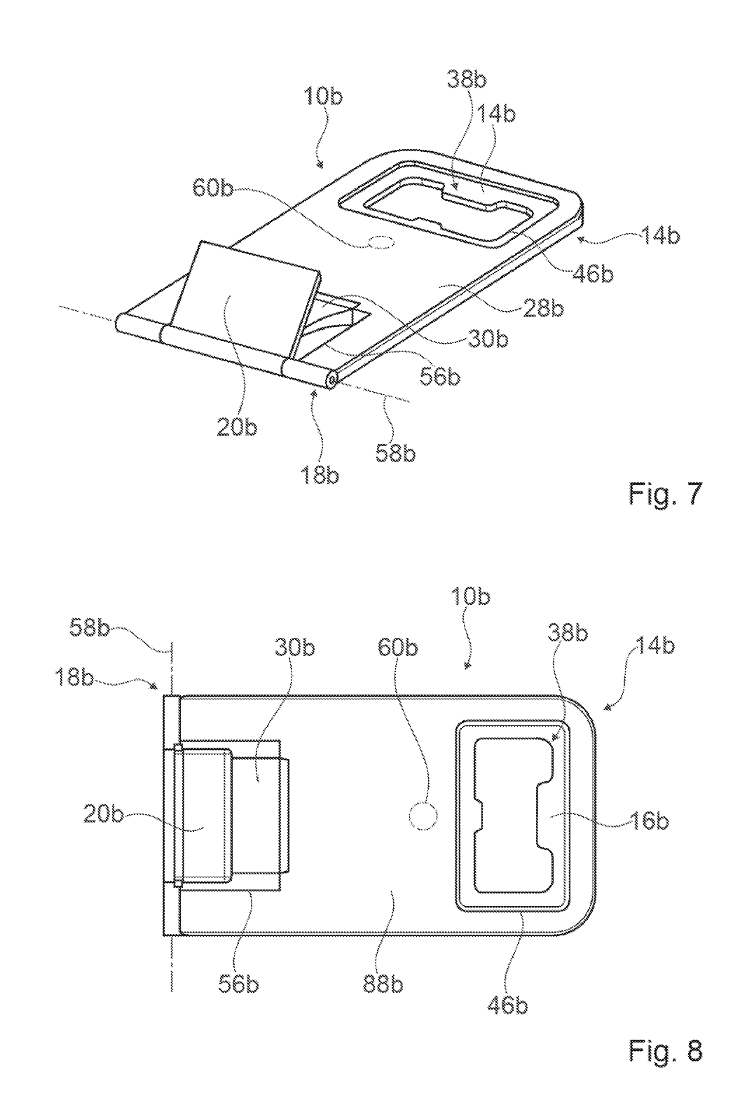

FIGS. 7 to 13 show further exemplary embodiments of the invention. The following description is substantially limited to the differences between the exemplary embodiments, wherein regarding structural elements, features and functions that remain the same the description of the other exemplary embodiments, in particular the exemplary embodiment of FIGS. 1 to 6, may be referred to. For distinguishing the exemplary embodiments, the letter a of the reference numerals in the exemplary embodiment of FIGS. 1 to 6 has been substituted by the letters b and c in the reference numerals of the exemplary embodiments of FIGS. 7 to 13. Regarding structural elements having the same denomination, in particular regarding structural elements having the same reference numerals, principally the drawing and/or the description of the other exemplary embodiments, in particular of the exemplary embodiment of FIGS. 1 to 6, may be referred to.

FIG. 7 shows a first alternative emergency door handle 10b in a perspective view. FIG. 8 shows the first alternative emergency door handle 10b in a schematic lateral view. The first alternative emergency door handle 10b is configured for opening a home appliance. The home appliance is not shown. The first alternative emergency door handle 10b comprises a handle unit 14b having a handle element 16b and an opening unit 18b with a protrusion element 20b for transmitting an opening force exerted onto the handle element 16b to a door of the home appliance.

The opening unit 18b features a support element 28b that is connected to the handle unit 14b. The protrusion element 20b is connected to the support element 28b.

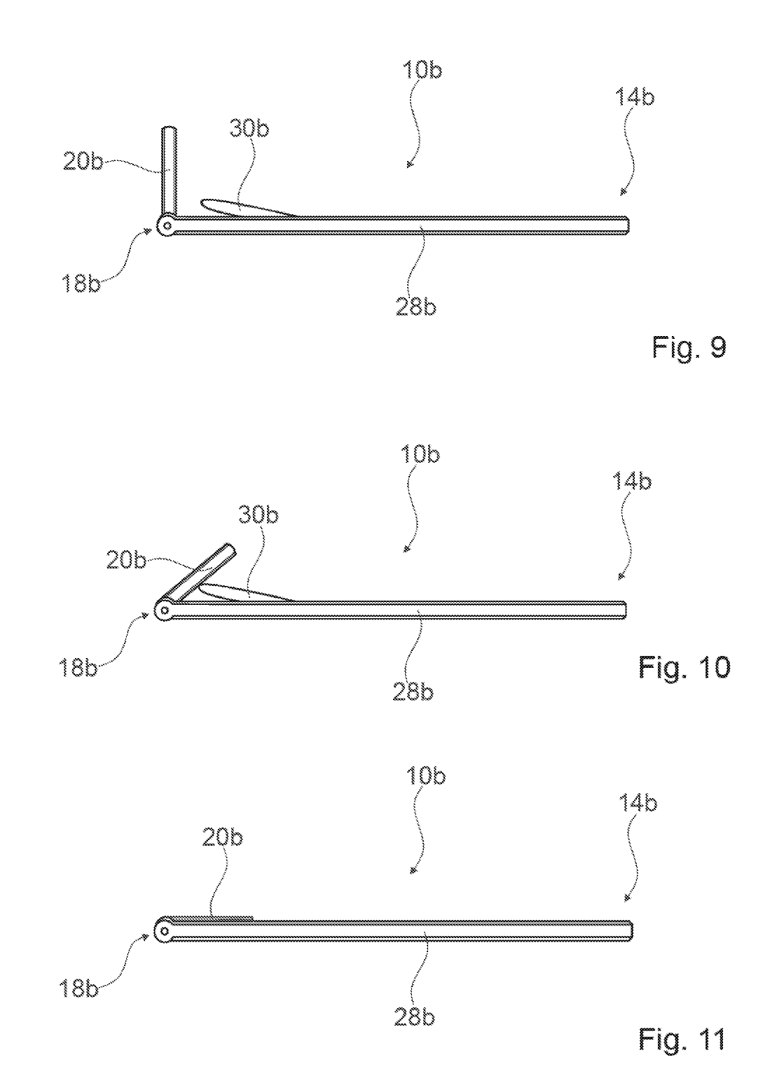

FIG. 9 shows the first alternative emergency door handle 10b in an opening position, in a schematic top view. FIG. 10 shows the first alternative emergency door handle 10b in a basic position, in a schematic top view. FIG. 11 shows the first alternative emergency door handle 10b in an advancement position, in a schematic top view.

In the basic position the protrusion element 20b is oriented inclined with respect to the support element 28b. The protrusion element 20b is movable into an advancement position. In the advancement position the protrusion element 20b is oriented at least substantially parallel to the support element 28b. The protrusion element 20b is pivot-mounted to the support element 28b. The protrusion element 20b is supported pivotally about a pivot axis 58b.

The opening unit 18b features a spring element 30b for restoring the protrusion element 20b into the basic position. The spring element 30b is mounted to the support element 28b. The spring element 30b is pivot-mounted to the support element 28b. The spring element 30b counteracts a force pushing the protrusion element 20b into the advancement position, for instance exerted by the door of the home appliance onto the protrusion element 20b when introducing the opening unit 18b into the home appliance. The support element 28b features a receiving recess 56b in which the spring element 30b is partly located. The receiving recess 56b is implemented as an opening. In the advancement position the spring element 30b and the protrusion element 20b are partly located in the receiving recess 56b.

The handle unit 14b comprises a functional unit 38b which provides an additional function. In the case shown the additional function is a kitchen tool function, in particular a bottle opener function. The functional unit 38b is at least partly implemented as a bottle opener. The functional unit 38b and the handle element 16b are at least partly implemented integrally with each other. In the case shown the handle element 16b implements the functional unit 38b.

In addition, the functional unit 38b is magnetic. The functional unit 38b is configured for connecting the first alternative emergency handle element 10b to a metal surface of the door of the home appliance.

The support element 28b is made of plastic. The handle element 16b is made of metal. The handle element 16b is at least partly inserted in the support element 28b. Furthermore, a magnet 60b is inserted in the support element 28b rendering the handle element 16b magnetic. The handle element 16b features a gripping opening 46b, which implements the bottle opener function.

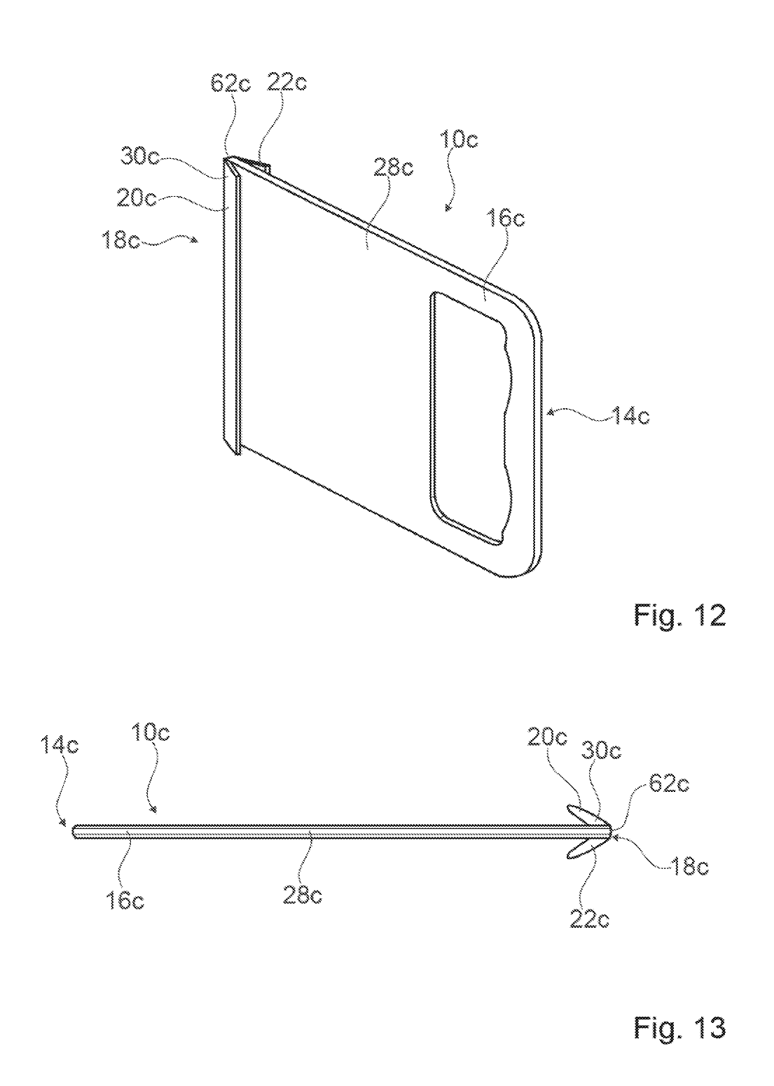

FIG. 12 shows a second alternative emergency door handle 10c in a perspective view. FIG. 13 shows the second alternative emergency door handle 10c in a perspective top view. The second alternative emergency door handle 10c is configured for opening a home appliance. The home appliance is not shown. The second alternative emergency door handle 10c comprises a handle unit 14c having a handle element 16v and an opening unit 18c having a protrusion element 20c for transmitting an opening force exerted onto the handle element 16c to a door of the home appliance.

The opening unit 18c features a support element 28c that is connected to the handle unit 14c. The support element 28c is plate-shaped. The handle element 16c is implemented integrally with the support element 28c. The protrusion element 20c is connected to the support element 28c. The protrusion element 20c is oriented inclined with respect to the support element 28c. The protrusion element 20c is arranged at a tip 62c of the support element 28c.

The protrusion element 20c is movable into an advancement position in which the protrusion element 20c is at least partly oriented at least substantially parallel to the support element 28c. The protrusion element 20c is partly macroscopically deformable. The protrusion element 20c is bendable towards the support element 28c.

The protrusion element 20c implements a spring element 30c which is configured for restoring the protrusion element 20c into at least one basic position. The protrusion element 20c is implemented integrally with the spring element 30c.

The support element 28c is made of plastic. The protrusion element 20c is made of plastic. The protrusion element 20c is at least partly made of a soft plastic, in particular a thermoplastic elastomer. The protrusion element 20c is at least partly made of a different plastic than the support element 28c. During manufacturing of the opening unit 18c, the support element 28c and the protrusion element 20c are fabricated in one common step, for instance using injection molding of two different plastic materials and/or co-extrusion.

The opening unit 18c features an additional protrusion element 22c. The additional protrusion element 22c is arranged opposite the protrusion element 20c. The additional protrusion element 22c is implemented mirror-symmetrically to the protrusion element 20c. Except for being implemented back-to-front, the additional protrusion element 22c is embodied identically to the protrusion element 20c. The protrusion element 20c and the additional protrusion element 22c form an arrowhead-shape together with the support element 28c.

The following is a summary list of reference numerals and the corresponding structure used in the above description of the invention:
10 emergency door handle
12 home appliance
14 handle unit
16 handle element
18 opening unit
20 protrusion element
22 protrusion element
24 protrusion element
26 door
28 support element
30 spring element
32 stop unit
34 stop element
35 stop element
36 maximum advancement length
38 functional unit
40 system
42 door
44 door opening assistant
46 gripping opening
48 advancement direction
50 method step
52 method step
54 gripping surface
56 receiving recess
58 pivot axis
60 magnet
62 tip
64 height direction

1. An emergency door handle configured for opening a home appliance, in particular a handle-less home appliance, for example a home chiller appliance, comprising: at least one handle unit having at least one handle element; and at least one opening unit having at least one protrusion element for transmitting an opening force exerted onto the handle element to a door of the home appliance.

2. The emergency door handle according to claim 1, the opening unit featuring at least one support element that is connected to the handle unit, the protrusion element being connected to the support element.

3. The emergency door handle according to claim 2, the protrusion element being oriented inclined with respect to the support element.

4. The emergency door handle according to claim 1, the protrusion element being movable into at least one advancement position, in which the protrusion element is at least partly oriented at least substantially parallel to the support element.

5. The emergency door handle according to claim 2, the support element being plate-shaped.

6. The emergency door handle according to claim 1, the protrusion element being at least partly macroscopically deformable.

7. The emergency door handle according to claim 1, the opening unit featuring at least one spring element for restoring the protrusion element into at least one basic position.

8. The emergency door handle according to claim 1, further comprising a stop unit with at least one stop element arranged between the handle unit and the opening unit, the stop unit defining a maximum advancement length of the opening unit.

9. The emergency door handle according to claim 8, the stop element being arranged perpendicularly to the handle element and/or arranged perpendicularly to the opening unit.

10. The emergency door handle according to claim 1, the handle unit comprising a functional unit which provides at least one additional function, in particular at least one additional kitchen tool function.

11. The emergency door handle according to claim 10, the functional unit and the handle element being at least partly implemented integrally with each other.

12. The emergency door handle according to claim 10, the functional unit being at least partly implemented as a bottle opener.

13. A system comprising at least one handle-less home appliance, for example a home chiller appliance, and at least one emergency door handle according to claim 1.

14. The system according to claim 13 wherein the home appliance is a home chiller appliance.

15. A method for opening a door of a home appliance, in at least one emergency case, wherein at least one emergency door handle according to claim 1 is used for opening the door.

16. The method according to claim 15, wherein the home appliance is a handle-less home appliance.

17. The method according to claim 16, wherein the home appliance is a home chiller appliance.

18. The method according to claim 15, comprising the step of pushing the emergency door handle into an opening of the home appliance along at least one advancement direction, wherein the at least one protrusion element engages behind at least an edge delimiting the opening, followed by the step of pulling the emergency door handle along a direction opposite to the at least one advancement direction, wherein the door will be opened.
